(19) United States
(12) Patent Application Publication
(10) Pub. No.: US 2022/0407086 A1
(43) Pub. Date: Dec. 22, 2022

(54) ANODE CATALYST MATERIALS FOR ELECTROCHEMICAL CELLS

(71) Applicant: Robert Bosch GmbH, Stuttgart (DE)

(72) Inventors: Soo KIM, Arlington, MA (US); Ulrich BERNER, Stuttgart (DE); Charles TUFFILE, Swansea, MA (US); Mordechai KORNBLUTH, Brighton, MA (US)

(21) Appl. No.: 17/349,317

(22) Filed: Jun. 16, 2021

(51) Int. Cl. H01M 4/90; C22C 5/04

(52) U.S. Cl. CPC H01M 4/9058; C22C 5/04; H01M 2004/8684

(57) ABSTRACT

An anode catalyst layer of an electrochemical cell includes an anode catalyst material. The anode catalyst material is a Pt-based alloy. The Pt-based alloy is a binary Pt-M alloy, where M is Ge, Se, Ag, Sb, Os, or Tl. The Pt-based alloy is a ternary Pt-M^{I}-M^{II} alloy, where M^{I} is Ru, Ge, or Mo, and M^{II} is Ir, Os, Tl, Au, Bi, Se, or Pd.

### TECHNICAL FIELD

The present disclosure relates to anode catalyst materials for electrochemical cells, for example, anode catalyst materials for fuel cells or electrolyzers.

### BACKGROUND

An electrochemical cell is a device capable of either generating electrical energy from chemical reactions (e.g. fuel cells) or using electrical energy to conduct chemical reactions (e.g. electrolyzers). Fuel cells have shown promise as an alternative power source for vehicles and other transportation applications. Fuel cells operate with a renewable energy carrier, such as hydrogen. Fuel cells also operate without toxic emissions or greenhouse gases. One of the current limitations of widespread adoption and use of this clean and sustainable technology is the relatively expensive cost of the fuel cell. A catalyst material (e.g. platinum catalyst) is included in both the anode and cathode catalyst layers of a fuel cell. The catalyst material is one of the most expensive components in the fuel cell.

Electrolyzers undergo an electrolysis process to split water into hydrogen and oxygen, providing a promising method for hydrogen generation from renewable resources. An electrolyzer, like a fuel cell, includes an anode and cathode catalyst layers separated by an electrolyte membrane. The electrolyte membrane may be a polymer, an alkaline solution, or a solid ceramic material. A catalyst material is included in the anode and cathode catalyst layers of the electrolyzer.

### SUMMARY

According to one embodiment, an anode catalyst layer of an electrochemical cell is disclosed. The anode catalyst layer of the electrochemical cell may include an anode catalyst material. The anode catalyst material may be a Pt-based alloy. The Pt-based alloy may be a binary Pt-M alloy, where M may be Ge, Se, Ag, Sb, Os, or Tl.

According to another embodiment, an anode catalyst layer of an electrochemical cell is disclosed. The anode catalyst layer of the electrochemical cell may include an anode catalyst material. The anode catalyst material may be a Pt-based alloy. The Pt-based alloy may be a ternary Pt-M^{I}-M^{II} alloy, where M^{I} may be Ru, Ge, or Mo, and M^{II} may be Ir, Os, Tl, Au, Bi, Se, or Pd.

According to yet another embodiment, an electrochemical cell is disclosed. The electrochemical cell may include an anode catalyst layer having an anode catalyst material. The anode catalyst material may be a Pt-based alloy. The Pt-based alloy may be a binary Pt-M alloy, where M is Ge, Se, Ag, Sb, Os or Tl. The Pt-based alloy may be a ternary Pt-M^{I}-M^{II} alloy, where M^{I} is Ru, Ge, or Mo, and M^{II} is Ir, Os, Tl, Au, Bi, Se, or Pd. The electrochemical cell may further include a cathode catalyst layer. The electrochemical cell may also include an electrolyte membrane situated between the anode and cathode catalyst layers.

### BRIEF DESCRIPTION OF THE DRAWINGS

FIG. 1 depicts a schematic side view of a PEM fuel cell.

FIG. 2 depicts a schematic diagram of a computing platform that may be utilized to implement a data-driven materials screening method.

FIG. 3 depicts a schematic phase diagram showing a reaction enthalpy (eV/atom) of a reaction between Pt_{0.67}Ru_{0.33} and OOH as a function of a molar fraction of OOH in a reaction environment.

FIG. 4 depicts a schematic diagram depicting a summary representation of several Pt_{0.67}M_{0.33} alloys.

FIG. 5 depicts a schematic perspective view of a fuel cell stack according to one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

This present disclosure is not limited to the specific embodiments and methods described below, as specific components and/or conditions may, of course, vary. Furthermore, the terminology used herein is used only for the purpose of describing embodiments of the present disclosure and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The term “substantially” may be used herein to describe disclosed or claimed embodiments. The term “substantially” may modify any value or relative characteristic disclosed or claimed in the present disclosure. “Substantially” may signify that the value or relative characteristic it modifies is within ±0%, 0.1%, 0.5%, 1%, 2%, 3%, 4%, 5% or 10% of the value or relative characteristic.

Reference is being made in detail to compositions, embodiments, and methods of embodiments known to the inventors. However, disclosed embodiments are merely exemplary of the present disclosure which may be embodied in various and alternative forms. Therefore, specific details disclosed herein are not to be interpreted as limiting, rather merely as representative bases for teaching one skilled in the art to variously employ the present disclosure.

Electrochemical cells show great potential as an alternative solution for energy production and consumption. For instance, fuel cells are being developed as electrical power sources for automobile applications, and electrolyzers are being used for hydrogen production from renewal resources (e.g. water). However, widespread adoption of the electrochemical cells requires further research into lifetime and cost reduction for components used in the electrochemical cells. These components include an electrolyte membrane and catalyst layers separated by the electrolyte membrane.

A typical single polymer electrolyte membrane (PEM) fuel cell is composed of a PEM, an anode layer, a cathode layer, and gas diffusion layers (GDLs). These components form a membrane electrode assembly (MEA), which is surrounded by two flow field plates. A catalyst material, such as platinum (Pt) catalysts, is included in the anode and cathode layers of the PEM fuel cell. At the anode layer, Pt catalysts catalyze a hydrogen oxidation reaction (HOR, H₂→2H⁺+2e⁻), where H₂ is oxidized to generate electrons and protons (H⁺). At the cathode layer, Pt catalysts catalyze an oxygen reduction reaction (ORR, ½O₂+2H⁺+2e⁻→H₂O), where O₂ reacts with H⁺ and is reduced to form water.

Due to dynamic changes of operational conditions in the PEM fuel cell, Pt catalysts may be subject to various degradations, including dissolution, migration, and re-deposition. In addition, because the kinetics of an ORR is significantly slower than that of an HOR, a higher loading of Pt catalysts is required at the cathode layer than the anode layer. Further, the sizes of Pt catalysts may grow during a normal operation of the PEM fuel cell. The growth of the Pt catalysts may cause a loss of an electrochemical surface area (ECSA), which adversely affects the HOR and/or ORR and leads to the degradation of the PEM fuel cell.

Global H₂ fuel starvation may occur, especially at the anode layer of the PEM fuel cell. The occurrence of H₂ fuel starvation may substantially impact the performance of the PEM fuel cell. Specifically, due to a lack of H₂ fuel, an oxygen evolution reaction (OER, 2H₂O→O₂+4H⁺+4e), i.e., water electrolysis, may occur at 1.23 V vs. standard hydrogen electrode (SHE) at the anode layer. A carbon oxidation reaction (COR, C+2H₂O→CO₂+4 H⁺+4e⁻) may also take place at 0.21 V vs. SHE at the anode layer. For a normal fuel cell operation, i.e., when there is no H₂ fuel starvation, a cathode voltage at the cathode layer is normally higher than the anode voltage at the anode layer, as the HOR takes place at 0.00 V vs. SHE. A cell terminal voltage between the cathode and anode voltages is normally above 0.00 V. However, when H₂ fuel starvation occurs, the OER and/or COR increases the anode voltage at the anode layer, causing the cell terminal voltage to decrease, i.e., causing cell voltage reversal. For example, the cell terminal voltage may drop below −2.00 V. In addition, the COR may lead to carbon corrosion at the anode layer. The occurrence of cell voltage reversal may also generate a significant amount of waste heat, which further damages the MEA and accelerates the degradation of the PEM fuel cell.

To alleviate or prevent cell voltage reversal due to H₂ fuel starvation, metal elements such as ruthenium (Ru) or iridium (Ir), as well as their metal oxides such as RuO₂ or IrO₂, may be added to the anode layer of the PEM fuel cell. The incorporation of Ru and/or Ir element may help reduce carbon corrosion at the anode layer during H₂ fuel starvation. For instance, a voltage of about 0.6 to 0.7 V is typically required to fully recover Pt surfaces from catalyst poisoning (i.e., to oxidize CO to CO₂ gas). However, due to the presence of Ru, about 0.35 V is required to fully recover Pt—Ru surfaces from catalyst poisoning. Furthermore, some Ir-based intermetallic compounds, such as IrRu₄Y_{0.5} or IrRu₄, may also be added to the anode layer to prevent carbon corrosion and/or water hydrolysis during H₂ fuel starvation. However, because these metals and metal oxides are relatively expensive, using them in the anode layer undesirably increase the total cost of the PEM fuel cell.

Therefore, there is a need for an electrochemical cell anode catalyst material that is not only relatively low-cost but comparatively effective as adding Ru and/or Ir element to the anode layer to prevent cell voltage reversal during H₂ fuel starvation. Aspects of the present disclosure are directed to anode catalyst materials for electrochemical cells, for example, anode catalyst materials for fuel cells or electrolyzers. The anode catalyst material may be a Pt-based alloy. In one embodiment, the Pt-based alloy may be a binary Pt-M alloy, where M may be Ge, Se, Ag, Sb, Os, or Tl. In another embodiment, the Pt-based alloy may be a ternary Pt-M^{I}-M^{II} alloy, where M^{I} may be Ru, Ge, or Mo, and M^{II} may be Ir, Os, Tl, Au, Bi, Se, or Pd.

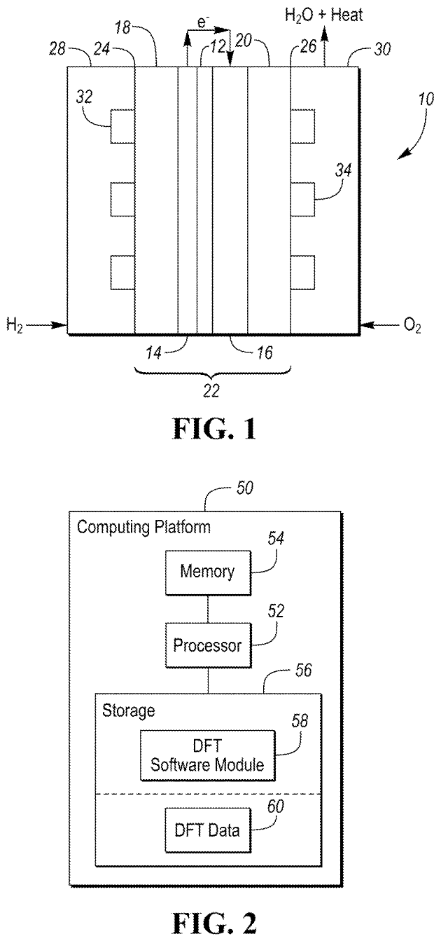

FIG. 1 depicts a schematic side view of a PEM fuel cell. The PEM fuel cell 10 may be stacked to create a fuel cell stack assembly. The PEM fuel cell 10 includes a PEM 12, an anode layer 14, a cathode layer 16, an anode GDL 18, and a cathode GDL 20. The PEM 12 is situated between the anode layer 14 and the cathode layer 16. The anode layer 14 is situated between the anode GDL 18 and the PEM 12, and the cathode layer 16 is situated between the cathode GDL 20 and the PEM 12. Further, the PEM 12, the anode 14, the cathode 16, and the anode and cathode GDLs 18 and 20 comprise a membrane electrode assembly (MEA) 22. An anode catalyst material is included in the anode layer 14, and a cathode catalyst material is included in the cathode layer 16. Each of the anode and cathode catalyst materials is supported on a catalyst support.

In addition, a first side 24 of the MEA 22 is bound by an anode flow field plate 28, and the second side 26 of the MEA 22 is bounded by a cathode flow field plate 30. The anode flow field plate 28 includes an anode flow field 32 configured to distribute H₂ to the MEA 22. The cathode flow field plate 30 includes a cathode flow field 34 configured to distribute O₂ to the MEA 22.

FIG. 2 depicts a schematic diagram of a computing platform that may be utilized to implement a data-driven materials screening method. The computing platform 50 may include a processor 52, a memory 54, and a non-volatile storage 56. The processor 52 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory 54 may include a single memory device or a number of memory devices including random access memory (RAM), volatile memory, non-volatile memory, static random-access memory (SRAM), dynamic random-access memory (DRAM), flash memory, cache memory, or any other device capable of storing information. The non-volatile storage 56 may include one or more persistent data storage devices such as a hard drive, optical drive, tape drive, non-volatile solid-state device, cloud storage or any other device capable of persistently storing information.

The processor 52 may be configured to read into memory and execute computer-executable instructions residing in a DFT software module 58 of the non-volatile storage 56 and embodying DFT slab model algorithms, calculations and/or methodologies of one or more embodiments. The DFT software module 58 may include operating systems and applications. The DFT software module 58 may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by the processor 52, the computer-executable instructions of the DFT software module 58 may cause the computing platform 50 to implement one or more of the DFT algorithms and/or methodologies disclosed herein. The non-volatile storage 56 may also include DFT data 60 supporting the functions, features, calculations, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. The computer readable storage medium, which is inherently non-transitory, may include volatile and non-volatile, and removable and non-removable tangible media implemented in any method or technology for storage of information, such as computer-readable instructions, data structures, program modules, or other data. The computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in the computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

Referring to FIG. 2, the data-driven materials screening method may be utilized to identify metal alloys that are suitable to be used as electrochemical cell anode catalyst materials for preventing cell voltage reversal during H₂ fuel starvation. The metal alloys may be Pt-based alloys. The metal alloys may be a binary Pt-M alloy, where M is a metal element other than Pt. The metal alloys may be a ternary Pt-M^{I}-M^{II} alloy, where both M^{I} and M^{II} are metal elements other than Pt. Particularly, the data-driven materials screening method may evaluate, for example, the thermodynamic stability of the metal alloys and the chemical reactivities of the metal alloys under an oxidizing environment. The oxidizing environment may be represented by the presence of oxidizing agents in an electrochemical cell environment. The oxidizing agents may be O, OH, and/or OOH. H₂O₂ is used as a proxy to describe H₂O+O or 2OH⁻ in the electrochemical cell environment.

Table 1 depicts information of reactions between Pt and O₂, H₂O₂, or OOH, respectively, under similar reaction conditions. Table 1 provides a reaction equation and a reaction enthalpy (E, eV/atom) for each reaction.

TABLE 1
Information of reactions between Pt
and O₂, H₂O₂, or OOH, respectively.

| | | E |
|---|---|---|
| Reactant | Equation of the reaction | (eV/atom) |
| O₂ | 0.3335 O₂ + 0.333 Pt → 0.333 PtO₂ | −0.937 |
| H₂O₂ | 0.4 H₂O₂ + 0.2 Pt → 0.2 PtO₂ + 0.4 H₂O | −0.385 |
| OOH | 0.571 HO₂ + 0.429 Pt → 0.429 PtO₂ + | −0.562 |
| | 0.286 H₂O | |

Table 2 depicts information of reactions between Ir and O₂, H₂O₂, or OOH, respectively, under similar reaction conditions. Table 2 provides a reaction equation and a reaction enthalpy (E, eV/atom) for each reaction.

TABLE 2
Information of reactions between Ir
and O₂, H₂O₂, or OOH, respectively.

| | | E |
|---|---|---|
| Reactant | Equation of the reaction | (eV/atom) |
| O₂ | 0.3335 O₂ + 0.333 Ir → 0.333 IrO₂ | −1.271 |
| H₂O₂ | 0.4 H₂O₂ + 0.2 Ir → 0.4 H₂O + 0.2 IrO₂ | −0.497 |
| OOH | 0.571 HO₂ + 0.429 Ir → 0.286 H₂O + 0.429 IrO₂ | −0.763 |

Table 3 depicts information of reactions between Ru and O₂, H₂O₂, or OOH, respectively, under similar reaction conditions. Table 3 provides a reaction equation and a reaction enthalpy (E, eV/atom) for each reaction.

TABLE 3
Information of reactions between Ru
and O₂, H₂O₂, or OOH, respectively.

| | | E |
|---|---|---|
| Reactant | Equation of the reaction | (eV/atom) |
| O₂ | 0.3335 O₂ + 0.333 Ru → 0.333 RuO₂ | −1.468 |
| H₂O₂ | 0.4 H₂O₂ + 0.2 Ru → 0.4 H₂O + 0.2 RuO₂ | −0.562 |
| OOH | 0.571 HO₂ + 0.429 Ru → 0.286 H₂O + | −0.881 |
| | 0.429 RuO₂ | |

In view of Tables 1 to 3, the reactions between Ir and O₂, H₂O₂, or OOH appear to be more favorable than the reactions between Pt and O₂, H₂O₂, or OOH, respectively. Further, the reactions between Ru and O₂, H₂O₂, or OOH appear to be more favorable than the reactions between Ir and O₂, H₂O₂, or OOH, respectively, and thus more favorable than the reactions between Pt and O₂, H₂O₂, or OOH, respectively. This indicates that when using either Ir or Ru alone as an anode catalyst in the anode layer of an electrochemical cell, the anode catalyst may be less stable than using Pt alone as the anode catalyst. Using either Ir or Ru alone as the anode catalyst in the anode layer may not help prevent cell voltage reversal during H₂ fuel starvation.

Table 4 depicts information of reactions between Pt_{0.75}Ir_{0.25} and O₂, H₂O₂, or OOH, respectively, under similar reaction conditions. Table 4 provides a reaction equation and a reaction enthalpy (E, eV/atom) for each reaction.

TABLE 4
Information of reactions between Pt_{0.75}Ir_{0.25} and O₂, H₂O₂, or OOH, respectively.

| | | E |
|---|---|---|
| Reactant | Equation of the reaction | (eV/atom) |
| O₂ | 0.3335 O₂ + 0.333 Ir_{0.25}Pt_{0.75} → 0.25 PtO₂ + 0.083 IrO₂ | −1.020 |
| H₂O₂ | 0.375 H₂O₂ + 0.25 Ir_{0.25}Pt_{0.75} → 0.063 Pt₃O₄ + 0.063 IrO₂ + 0.375 H₂O | −0.416 |
| OOH | 0.571 HO₂ + 0.429 Ir_{0.25}Pt_{0.75} → 0.321 PtO₂ + 0.107 IrO₂ + 0.286 H₂O | −0.612 |

Table 5 depicts information of reactions between Pt_{0.75}Ru_{0.25} and O₂, H₂O₂, or OOH, respectively, under similar reaction conditions. Table 5 provides a reaction equation and a reaction enthalpy (E, eV/atom) for each reaction.

TABLE 5
Information of reactions between Pt_{0.75}Ru_{0.25} and O₂, H₂O₂, or OOH, respectively.

| | | E |
|---|---|---|
| Reactant | Equation of the reaction | (eV/atom) |
| O₂ | 0.3335 O₂ + 0.333 Ru_{0.25}Pt_{0.75} → 0.25 PtO₂ + 0.083 RuO₂ | −1.070 |
| H₂O₂ | 0.375 H₂O₂ + 0.25 Ru_{0.25}Pt_{0.75} → 0.063 Pt₃O₄ + 0.063 RuO₂ + 0.375 H₂O | −0.437 |
| OOH | 0.571 HO₂ + 0.429 Ru_{0.25}Pt_{0.75} → 0.321 PtO₂ + 0.107 RuO₂ + 0.286 H₂O | −0.642 |

In view of Tables 2 and 4, the reactions between Pt_{0.75}Ir_{0.25} and O₂, H₂O₂, or OOH appears to be less favorable than the reactions between Ir and O₂, H₂O₂, or OOH, respectively. This suggests that adding Ir to Pt, thereby forming a Pt—Ir alloy, may help increase the stability of the anode catalyst as compared to using Ir alone as the anode catalyst in the anode layer of the electrochemical cell.

Similarly, in view of Tables 3 and 5, the reactions between Pt_{0.75}Ru_{0.25} and O₂, H₂O₂, or OOH appear to be less favorable than the reactions between Ru and O₂, H₂O₂, or OOH, respectively. Adding Ru to Pt, thereby forming a Pt—Ru alloy, may also help increase the stability of the anode catalyst as compared to using Ru alone as the anode catalyst in the anode layer of the PEM fuel cell.

Further, when comparing the chemical reactivities of Pt_{0.75}Ir_{0.25} and Pt_{0.75}Ru_{0.25} in Tables 4 and 5, Pt_{0.75}Ir_{0.25} appears to be less chemically reactive against O₂, H₂O₂, or OOH than Pt_{0.75}Ru_{0.25}. This further indicates that Pt_{0.75}Ir_{0.25} may be more suitable than Pt_{0.75}Ru_{0.25} to be used as an electrochemical cell anode catalyst material to prevent cell voltage reversal during H₂ fuel starvation.

Apart from Pt—Ir and Pt—Ru alloys, other metal elements M, such as palladium (Pd) or cerium (Ce), may be mixed with Pt to form Pt-M alloys. Table 6 depicts information of reactions between Pt_{0.75}Pd_{0.25} and O₂, H₂O₂, or OOH, respectively, under similar reaction conditions. Table 6 provides a reaction equation and a reaction enthalpy (E, eV/atom) for each reaction.

TABLE 6
Information of reactions between Pt_{0.75}Pd_{0.25} and O₂, H₂O₂, or OOH, respectively.

| | | E |
|---|---|---|
| Reactant | Equation of the reaction | (eV/atom) |
| O₂ | 0.318 O₂ + 0.364 Pd_{0.25}Pt_{0.75} → 0.273 PtO₂ + 0.091 PdO | −0.905 |
| H₂O₂ | 0.389 H₂O₂ + 0.222 Pd_{0.25}Pt_{0.75} → 0.167 PtO₂ + 0.056 PdO + 0.389 H₂O | −0.383 |
| OOH | 0.538 HO₂ + 0.462 Pd_{0.25}Pt_{0.75} → 0.346 PtO₂ + 0.115 PdO + 0.269 H₂O | −0.553 |

Table 7 depicts information of reactions between Pt_{0.75}Ce_{0.25} and O₂, H₂O₂, or OOH, respectively, under similar reaction conditions. Table 7 provides a reaction equation and a reaction enthalpy (E, eV/atom) for each reaction.

TABLE 7
Information of reactions between Pt_{0.75}Ce_{0.25} and O₂, H₂O₂, or OOH, respectively.

| | | E |
|---|---|---|
| Reactant | Equation of the reaction | (eV/atom) |
| O₂ | 0.3 O₂ + 0.4 Ce_{0.25}Pt_{0.75} → 0.1 Pt₃O₄ + 0.1 CeO₂ | −1.381 |
| H₂O₂ | 0.5 Ce_{0.25}Pt_{0.75} + 0.25 H₂O₂ → 0.25 H₂O + 0.125 CeO₂ + 0.375 Pt | −0.718 |
| OOH | 0.75 Ce_{0.25}Pt_{0.75} + 0.25 HO₂ → 0.125 H₂O + 0.188 CeO₂ + 0.562 Pt | −0.995 |

In view of Tables 6 and 7, the reactions between Pt_{0.75}Pd_{0.25} and O₂, H₂O₂, or OOH appear to be less favorable than the reactions between Pt_{0.75}Ce_{0.25} and O₂, H₂O₂, or OOH, respectively. This indicates that Pt_{0.75}Pd_{0.25} may be more stable than Pt_{0.75}Ce_{0.25} in an oxidizing environment. In other words, adding Pd to Pt, thereby forming a Pt—Pd alloy, may help increase the stability of the anode catalyst as compared to adding the same amount of Ce to Pt to form a Pt—Ce alloy.

Further, when comparing the chemical reactivities of Pt_{0.75}Pd_{0.25} and Pt_{0.75}Ir_{0.25} in Tables 4 and 6, Pt_{0.75}Pd_{0.25} appears to be less chemically reactive against O₂, H₂O₂, or OOH than Pt_{0.75}Ir_{0.25}. This further indicates that Pt_{0.75}Pd_{0.25} may be more suitable than Pt_{0.75}Ir_{0.25} to be used as a fuel cell anode catalyst material to prevent cell voltage reversal during H₂ fuel starvation.

To further examine the chemical reactivity of a Pt-M alloy against O₂, H₂O₂, or OOH, the data-driven materials screening method may be utilized to identify other Pt-M alloys that are suitable to be used as electrochemical cell anode catalyst materials to prevent cell voltage reversal during H₂ fuel starvation. In addition to Ru, Ir, Pd, and Ce, M may also be, for example, titanium (Ti), germanium (Ge), selenium (Se), zirconium (Zr), niobium (Nb), molybdenum (Mo), rhodium (Rh), silver (Ag), tin (Sn), antimony (Sb), hafnium (Hf), tantalum (Ta), tungsten (W), rhenium (Re), osmium (Os), gold (Au), thallium (Tl), or bismuth (Bi).

Table 8 depicts information of thermodynamic decomposition products of a Pt-M alloy, where M may be Ti, Ge, Se, Zr, Nb, Mo, Ru, Rh, Pd, Ag, Sn, Sb, Ce, Hf, Ta, W, Re, Os, Ir, Au, Tl, or Bi. Each Pt-M alloy in Table 8 shows a ratio of Pt to M as 2, i.e., Pt_{0.67}M_{0.33}. Pt_{0.67}M_{0.33} may also be represented as PtₓM_{y}, where x=2y, x>0, and M may be Ti, Ge, Se, Zr, Nb, Mo, Ru, Rh, Pd, Ag, Sn, Sb, Ce, Hf, Ta, W, Re, Os, Ir, Au, Tl, or Bi. Noted that Pt-M alloys having ratios of Pt to M other than 2 may similarly be evaluated using the method described herein. For instance, in some other embodiments, the data-driven materials screening method may be utilized to evaluate Pt-M alloys, such as Pt_{0.95}M_{0.05} or Pt_{0.5}M_{0.5}, where M may be Ti, Ge, Se, Zr, Nb, Mo, Ru, Rh, Pd, Ag, Sn, Sb, Ce, Hf, Ta, W, Re, Os, Ir, Au, Tl, or Bi, to identify those suitable to be used as electrochemical cell anode catalyst materials to prevent cell voltage reversal during H₂ fuel starvation.

Table 8 provides a thermodynamic decomposition reaction of each Pt-M alloy. The thermodynamic decomposition products of each reaction are obtained using “interface reactions” module kit available on materialsproject.org. Among the thermodynamic decomposition products of each reaction, some are cubic phases, and some are non-cubic phases. A percentage of the non-cubic phases of the thermodynamic decomposition products for each reaction may be calculated. For example, the thermodynamic decomposition products of Pt_{0.67}Ru_{0.33} may be 0.67 Pt and 0.33 Ru, where Pt belongs to a cubic crystal system (Fm-3m), and Ru belongs to a hexagonal crystal system (P6₃/mmc). Therefore, the percentage of the non-cubic phases of the thermodynamic decomposition products for Pt_{0.67}Ru_{0.33} is calculated as 0.33/(0.67+0.33), which is about 0.33. Table 8 further provides a penalty point (PP1) to indicate the percentage of the non-cubic phases of the thermodynamic decomposition products for each reaction. For easy comparison, a PP1 of 0 is assigned to the scenario where 100% of the thermodynamic decomposition products are cubic phases. As such, the PP1 for Pt_{0.67}Ru_{0.33} is 0.330.

TABLE 8
Information of thermodynamic decomposition products of a Pt-M
alloy, where M may be Ti, Ge, Se, Zr, Nb, Mo, Ru, Rh, Pd,
Ag, Sn, Sb, Ce, Hf, Ta, W, Re, Os, Ir, Au, Tl, or Bi.

| M | Thermodynamic decomposition reaction | PP1 |
|---|---|---|
| Ti | Ti_{0.33}Pt_{0.67} → 0.08 Ti₃Pt₅ + 0.09 TiPt₃ | 1.000 |
| Ge | Ge_{0.33}Pt_{0.67} → 0.107 Ge₂Pt₃ + 0.117 GePt₃ | 1.000 |
| Se | Pt_{0.67}Se_{0.33} → 0.083 Pt₅Se₄ + 0.258 Pt | 0.243 |
| Zr | Zr_{0.33}Pt_{0.67} → 0.029 Zr₇Pt₁₀ + 0.126 ZrPt₃ | 1.000 |
| Nb | Nb_{0.33}Pt_{0.67} → 0.32 NbPt₂ + 0.01 NbPt₃ | 1.000 |
| Mo | Mo_{0.33}Pt_{0.67} → 0.33 MoPt₂ + 0.01 Pt | 0.971 |
| Ru | Ru_{0.33}Pt_{0.67} → 0.33 Ru + 0.67 Pt | 0.330 |
| (reference) | | |
| Rh | Pt_{0.67}Rh_{0.33} → 0.21 Pt₃Rh + 0.04 PtRh₃ | 1.000 |
| Pd | Pd_{0.33}Pt_{0.67} → 0.33 PdPt + 0.34 Pt | 0.500 |
| Ag | Ag_{0.33}Pt_{0.67} → 0.113 AgPt₄ + 0.217 AgPt | 1.000 |
| Sn | Sn_{0.33}Pt_{0.67} → 0.17 SnPt₃ + 0.16 SnPt | 0.500 |
| Sb | Sb_{0.33}Pt_{0.67} → 0.165 Sb₂Pt₃ + 0.175 Pt | 0.485 |
| Ce | Ce_{0.33}Pt_{0.67} → 0.064 Ce₃Pt₄ + 0.138 CePt₃ | 0.317 |
| Hf | Hf_{0.33}Pt_{0.67} → 0.17 HfPt₃ + 0.16 HfPt | 1.000 |
| Ta | Ta_{0.33}Pt_{0.67} → 0.01 TaPt₃ + 0.32 TaPt₂ | 1.000 |
| W | Pt_{0.67}W_{0.33} → 0.33 Pt₂W + 0.01 Pt | 0.971 |
| Re | Re_{0.33}Pt_{0.67} → 0.11 Re₃Pt + 0.56 Pt | 0.164 |
| Os | Os_{0.33}Pt_{0.67} → 0.33 Os + 0.67 Pt | 0.333 |
| Ir | Ir_{0.33}Pt_{0.67} → 0.33 Ir + 0.67 Pt | 0.333 |
| Au | Pt_{0.67}Au_{0.33} → 0.67 Pt + 0.33 Au | 0.333 |
| Tl | Tl_{0.33}Pt_{0.67} → 0.165 Tl₂Pt₃ + 0.175 Pt | 0.485 |
| Bi | Bi_{0.33}Pt_{0.67} → 0.34 Pt + 0.33 BiPt | 0.500 |

To determine the percentage of cubic or non-cubic phases in the thermodynamic decomposition products of an alloy, such as a Pt-based alloy, X-ray diffraction (XRD) techniques may be employed. Particularly, an XRD pattern of a cubic phase may show strong signature peaks at (111), (110), and/or (100), representing face-centered cubic (fcc) characters. On the other hand, an XRD pattern of a non-cubic phase may show small impurity peaks, which can be differentiated from the signature peaks for cubic phases. In addition, the XRD techniques may be used to determine an average crystallite size of a Pt-based alloy nanoparticle. A size distribution of the Pt-based alloy nanoparticles may be determined using high-resolution transmission electron microscope (HR-TEM) imaging techniques. An average size of a Pt-based alloy nanoparticle may be in a range of 1 and 20 nm, or alternatively, between 3 and 10 nm.

In addition to the composition of the Pt-based alloy, the properties of the Pt-based alloy may also vary depending on its microstructure, morphology, and/or crystallinity. A lattice mismatch between the thermodynamic decomposition products of the Pt-based alloy may impact a local structure and/or electronic structure of the alloy. When the Pt-based alloy nanoparticles are de-alloyed near a surface, a lattice constant in a bulk region may decrease, thereby leading to a compressive strain at an outer Pt surface. In general, such an effect may increase the catalyst activity. Further, introducing tensile strain and/or increasing lattice constants may enhance the durability of the Pt-based alloy.

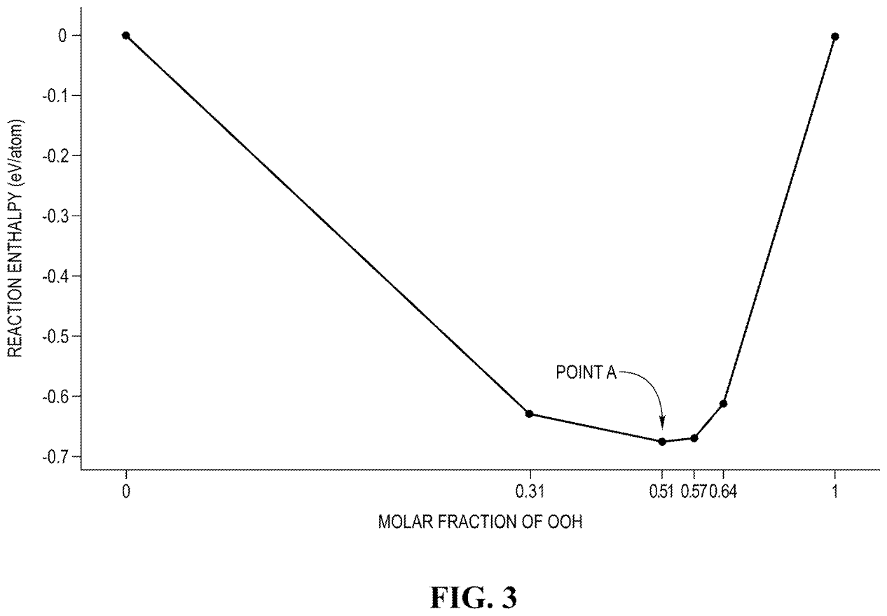

FIG. 3 depicts a schematic phase diagram showing a reaction enthalpy (eV/atom) of a reaction between Pt_{0.67}Ru_{0.33} and OOH as a function of a molar fraction of OOH in a reaction environment. The reaction environment may be an electrochemical cell operating environment, especially during H₂ fuel starvation. The molar faction of OOH is in a range of 0 and 1. As shown in FIG. 3, when the molar faction of OOH is 0, there is no OOH and 100% of Pt_{0.67}Ru_{0.33} in the reaction environment. Conversely, when the molar faction of OOH is 1, there is no Pt_{0.67}Ru_{0.33} but 100% OOH in the reaction environment. As the molar fraction of OOH increases from 0, the most stable decomposition reaction may occur at Point A, where the molar fraction of OOH is about 0.509 and the reaction enthalpy of the most stable decomposition reaction is about −0.672 eV/atom. Reaction (1) is included hereby to illustrate the most stable decomposition reaction between Pt_{0.67}Ru_{0.33} and OOH:

0.509OOH+0.491Ru_{0.33}Pt_{0.67}→0.11Pt₃O₄+0.162RuO₂+0.254H₂O (1)

According to Reaction (1), after reacting with 0.509 OOH, Pt_{0.67}Ru_{0.33} is turned into 0.11 Pt₃O₄ and 0.162 RuO₂.

Using the same evaluation method as described in FIG. 3, the most stable decomposition reaction between each Pt_{0.67}M_{0.33} and OOH may be evaluated, where M may be Ti, Ge, Se, Zr, Nb, Mo, Rh, Pd, Ag, Sn, Sb, Ce, Hf, Ta, W, Re, Os, Ir, Au, Tl, or Bi. Table 9 depicts information of the most stable decomposition reaction between each Pt_{0.67}M_{0.33} and OOH. Particularly, Table 9 provides a reaction equation of the most stable decomposition reaction between each Pt_{0.67}M_{0.33} and OOH. Table 9 also provides a molar fraction between OOH and each Pt_{0.67}M_{0.33} for each reaction. Information of the most stable decomposition reaction between Pt_{0.67}Ru_{0.33} and OOH is used as a reference for comparison. Table 9 further provides a penalty point (e.g. PP2) regarding the molar fraction, where PP2 of 1.000 is assigned to the reference reaction between OOH and Pt_{0.67}Ru_{0.33} (i.e. the molar fraction is 1.040). PP2 is calculated by dividing the molar fraction between OOH and Pt_{0.67}Ru_{0.33} by the molar fraction between OOH and each Pt_{0.67}M_{0.33} of each reaction. For example, since the molar fraction between OOH and Pt_{0.67}Ti_{0.33} is 0.441, PP2 thus equals 1.040/0.441, which is about 2.351.

Table 9 also provides a reaction enthalpy (E, eV/atom) of the most stable decomposition reaction between each Pt_{0.67}M_{0.33} and OOH. Table 9 further provides a penalty point (e.g. PP3) regarding the reaction enthalpy, where PP3 of 1.000 is assigned to the reference reaction between OOH and Pt_{0.67}Ru_{0.33} (i.e. −0.672 eV/atom). PP3 is calculated by dividing the reaction enthalpy between OOH and each Pt_{0.67}M_{0.33} of each reaction by that between OOH and Pt_{0.67}Ru_{0.33}. For example, since the reaction enthalpy of the reaction between OOH and Pt_{0.67}Ti_{0.33} is −1.107 eV/atom, PP3 thus equals −1.107/−0.672, which is about 1.647.

If both the molar fraction between OOH and Pt_{0.67}M_{0.33}, and the reaction enthalpy of the reaction between OOH and Pt_{0.67}M_{0.33} are greater than those for Pt_{0.67}Ru_{0.33}, it may indicate that the Pt_{0.67}M_{0.33} is more stable than Pt_{0.67}Ru_{0.33}, and thus, more suitable to be used as an electrochemical cell anode catalyst material to prevent cell voltage reversal during H₂ fuel starvation. For example, because the molar fraction between OOH and Pt_{0.67}Pd_{0.33} (i.e. 1.114) and the reaction enthalpy of the most stable decomposition reaction between OOH and Pt_{0.67}Pd_{0.33} (i.e., −0.548 eV/atom) are both greater than those for Pt_{0.67}Ru_{0.33}, Pt_{0.67}Pd_{0.33} may therefore be more stable than Pt_{0.67}Ru_{0.33}, consistent with the observation in Tables 5 and 6. For another example, because the molar fraction between OOH and Pt_{0.67}Ce_{0.33} (i.e. 0.441) and the reaction enthalpy of the most stable decomposition reaction between OOH and Pt_{0.67}Ce_{0.33} (i.e., −1.241 eV/atom) are both less than those for Pt_{0.67}Ru_{0.33}, Pt_{0.67}Ce_{0.33} may therefore be less stable than Pt_{0.67}Ru_{0.33}, consistent with the observation in Tables 6 and 7.

TABLE 9
Information of the most stable decomposition reaction between each Pt_{0.67}M_{0.33} and OOH, where
M may be Ti, Ge, Se, Zr, Nb, Mo, Rh, Pd, Ag, Sn, Sb, Ce, Hf, Ta, W, Re, Os, Ir, Au, Tl, or Bi.

| | Equation of the most stable decomposition reaction | Molar | | E | |
|---|---|---|---|---|---|
| M | between Pt_{0.67}M_{0.33} and OOH | fraction | PP2 | (eV/atom) | PP3 |
| Ru | 0.509 HO₂ + 0.491 Ru_{0.33}Pt_{0.67} → 0.11 Pt₃O₄ + 0.162 | 1.040 | 1.000 | −0.672 | 1.000 |
| (reference) | RuO2 + 0.254 H₂O | | | | |
| Ti | 0.306 HO₂ + 0.694 Ti_{0.33}Pt_{0.67} → 0.153 H₂O + 0.229 | 0.441 | 2.351 | −1.107 | 1.647 |
| | TiO₂ + 0.465 Pt | | | | |
| Ge | 0.509 HO₂ + 0.491 Ge_{0.33}Pt_{0.67} → 0.11 Pt₃O₄ + 0.162 | 1.037 | 1.000 | −0.730 | 1.086 |
| | GeO₂ + 0.254 H₂O | | | | |
| Se | 0.429 Pt_{0.67}Se_{0.33} + 0.571 HO₂ → 0.287 PtO₂ + 0.286 | 1.331 | 0.779 | −0.563 | 0.838 |
| | H₂O + 0.141 SeO₂ | | | | |
| Zr | 0.306 HO₂ + 0.694 Zr_{0.33}Pt_{0.67} → 0.153 H₂O + 0.229 | 0.441 | 2.351 | −1.180 | 1.756 |
| | ZrO₂ + 0.465 Pt | | | | |
| Nb | 0.355 HO₂ + 0.645 Nb_{0.33}Pt_{0.67} → 0.106 Nb₂O₅ + 0.177 | 0.550 | 1.884 | −1.069 | 1.591 |
| | H₂O + 0.432 Pt | | | | |
| Mo | 0.602 Mo_{0.33}Pt_{0.67} + 0.398 HO₂ → 0.199 MoO₃ + 0.199 | 0.661 | 1.568 | −0.776 | 1.155 |
| | H₂O + 0.404 Pt | | | | |
| Rh | 0.571 HO₂ + 0.429 Pt_{0.67}Rh_{0.33} → 0.287 PtO₂ + 0.286 | 1.331 | 0.779 | −0.619 | 0.921 |
| | H₂O + 0.141 RhO₂ | | | | |
| Pd | 0.527 HO₂ + 0.473 Pd_{0.33}Pt_{0.67} → 0.317 PtO₂ + 0.156 | 1.114 | 0.930 | −0.548 | 0.815 |
| | PdO + 0.263 H₂O | | | | |
| Ag | 0.472 HO₂ + 0.528 Ag_{0.33}Pt_{0.67} → 0.354 PtO₂ + 0.236 | 0.940 | 1.103 | −0.502 | 0.747 |
| | H₂O + 0.174 Ag | | | | |
| Sn | 0.491 Sn_{0.33}Pt_{0.67} + 0.509 HO₂ → 0.11 Pt₃O₄ + 0.162 | 1.037 | 1.000 | −0.722 | 1.074 |
| | SnO₂ + 0.254 H₂O | | | | |
| Sb | 0.509 HO₂ + 0.491 Sb_{0.33}Pt_{0.67} → 0.11 Pt₃O₄ + 0.162 | 1.037 | 1.000 | −0.691 | 1.028 |
| | SbO₂ + 0.254 H₂O | | | | |
| Ce | 0.694 Ce_{0.33}Pt_{0.67} + 0.306 HO₂ → 0.153 H₂O + 0.229 | 0.441 | 2.351 | −1.241 | 1.847 |
| | CeO₂ + 0.465 Pt | | | | |
| Hf | 0.306 HO₂ + 0.694 Hf_{0.33}Pt_{0.67} → 0.153 H₂O + 0.229 | 0.441 | 2.351 | −1.242 | 1.848 |
| | HfO₂ + 0.465 Pt | | | | |
| Ta | 0.355 HO₂ + 0.645 Ta_{0.33}Pt_{0.67} → 0.177 H₂O + 0.106 | 0.550 | 1.884 | −1.180 | 1.756 |
| | Ta₂O₅ + 0.432 Pt | | | | |
| W | 0.602 Pt_{0.67}W_{0.33} + 0.398 HO₂ → 0.199 WO₃ + 0.199 | 0.661 | 1.568 | −0.852 | 1.268 |
| | H₂O + 0.404 Pt | | | | |
| Re | 0.398 HO₂ + 0.602 Re_{0.33}Pt_{0.67} → 0.199 H₂O + 0.199 | 0.661 | 1.568 | −0.916 | 1.363 |
| | ReO₃ + 0.404 Pt | | | | |
| Os | 0.596 HO₂ + 0.404 Os_{0.33}Pt_{0.67} → 0.09 Pt₃O₄ + 0.133 | 1.475 | 0.703 | −0.709 | 1.055 |
| | OsO₄ + 0.298 H₂O | | | | |
| Ir | 0.571 HO₂ + 0.429 Ir_{0.33}Pt_{0.67} → 0.287 PtO₂ + 0.141 | 1.331 | 0.779 | −0.628 | 0.935 |
| | IrO₂ + 0.286 H₂O | | | | |
| Au | 0.472 HO₂ + 0.528 Pt_{0.67}Au_{0.33} → 0.354 PtO₂ + 0.236 | 0.894 | 1.160 | −0.512 | 0.762 |
| | H₂O + 0.174 Au | | | | |
| Tl | 0.55 HO₂ + 0.45 Tl_{0.33}Pt_{0.67} → 0.153 PtO₂ + 0.074 | 1.222 | 0.848 | −0.637 | 0.948 |
| | Tl₂Pt₂O₇ + 0.275 H₂O | | | | |
| Bi | 0.517 HO₂ + 0.483 Bi_{0.33}Pt_{0.67} → 0.08 Bi₂Pt₂O₇ + 0.055 | 1.070 | 0.968 | −0.692 | 1.030 |
| | Pt₃O₄ + 0.259 H₂O | | | | |

Table 10 depicts information of the most stable decomposition reaction between each Pt_{0.67}M_{0.33} and H₂O₂. Particularly, Table 10 provides a reaction equation of the most stable decomposition reaction between each Pt_{0.67}M_{0.33} and H₂O₂. Table 10 also provides a molar fraction between H₂O₂ and each Pt_{0.67}M_{0.33} for each reaction. Information of the most stable decomposition reaction between Pt_{0.67}Ru_{0.33} and H₂O₂ is used as a reference for comparison. Table 10 further provides a penalty point (e.g. PP4) regarding the molar fraction, where PP4 of 1.000 is assigned to the reference reaction between H₂O₂ and Pt_{0.67}Ru_{0.33} (i.e. the molar fraction is 1.320). PP4 is calculated by dividing the molar fraction between H₂O₂ and Pt_{0.67}Ru_{0.33} by the molar fraction between H₂O₂ and each Pt_{0.67}M_{0.33} of each reaction. For example, since the molar fraction between H₂O₂ and Pt_{0.67}Ti_{0.33} is 1.320, PP4 thus equals 1.320/1.320, which is about 1.000.

Table 10 also provides a reaction enthalpy (E, eV/atom) of the most stable decomposition reaction between each Pt_{0.67}M_{0.33} and H₂O₂. Table 10 further provides a penalty point (e.g. PP5) regarding the reaction enthalpy, where PP5 of 1.000 is assigned to the reference reaction between H₂O₂ and Pt_{0.67}Ru_{0.33} (i.e. −0.459 eV/atom). PP5 is calculated by dividing the reaction enthalpy between H₂O₂ and each Pt_{0.67}M_{0.33} of each reaction by that between H₂O₂ and Pt_{0.67}Ru_{0.33}. For example, since the reaction enthalpy of the reaction between H₂O₂ and Pt_{0.67}Ti_{0.33} is −0.765 eV/atom, PP5 thus equals −0.765/−0.459, which is about 1.667.

If both the molar fraction between H₂O₂ and Pt_{0.67}M_{0.33}, and the reaction enthalpy of the reaction between H₂O₂ and Pt_{0.67}M_{0.33} are greater than those for Pt_{0.67}Ru_{0.33}, it may indicate that the Pt_{0.67}M_{0.33} is more stable than Pt_{0.67}Ru_{0.33}. Otherwise, Pt_{0.67}M_{0.33} may be less stable than Pt_{0.67}Ru_{0.33}.

TABLE 10
Information of the most stable decomposition reaction between Pt_{0.67}M_{0.33} and H₂O₂, where
M may be Ti, Ge, Se, Zr, Nb, Mo, Rh, Pd, Ag, Sn, Sb, Ce, Hf, Ta, W, Re, Os, Ir, Au, Tl, or Bi.

| | Equation of the most stable decomposition reaction | Molar | | E | |
|---|---|---|---|---|---|
| M | between Pt_{0.67}M_{0.33} and H₂O₂ | fraction | PP4 | (eV/atom) | PP5 |
| Ru | 0.2845 H₂O₂ + 0.431 Ru_{0.33}Pt_{0.67} → 0.142 RuO₂ + | 1.320 | 1.000 | −0.459 | 1.000 |
| (reference) | 0.284 H₂O + 0.289 Pt | | | | |
| Ti | 0.2845 H₂O₂ + 0.431 Ti_{0.33}Pt_{0.67} → 0.284 H₂O + | 1.320 | 1.000 | −0.765 | 1.667 |
| | 0.142 TiO₂ + 0.289 Pt | | | | |
| Ge | 0.2845 H₂O₂ + 0.431 Ge_{0.33}Pt_{0.67} → 0.142 GeO₂ + | 1.320 | 1.000 | −0.525 | 1.144 |
| | 0.284 H₂O + 0.289 Pt | | | | |
| Se | 0.2 Pt_{0.67}Se_{0.33} + 0.4 H₂O₂ → 0.134 PtO₂ + 0.4 H₂O + | 4.000 | 0.330 | −0.386 | 0.841 |
| | 0.066 SeO₂ | | | | |
| Zr | 0.2845 H₂O₂ + 0.431 Zr_{0.33}Pt_{0.67} → 0.284 H₂O + | 1.320 | 1.000 | −0.812 | 1.769 |
| | 0.142 ZrO₂ + 0.289 Pt | | | | |
| Nb | 0.3115 H₂O₂ + 0.377 Nb_{0.33}Pt_{0.67} → 0.062 Nb₂O₅ + | 0.826 | 1.598 | −0.722 | 1.573 |
| | 0.311 H₂O + 0.253 Pt | | | | |
| Mo | 0.431 Mo_{0.33}Pt_{0.67} + 0.2845 H₂O₂ → 0.284 H₂O + | 1.320 | 1.000 | −0.544 | 1.185 |
| | 0.142 MoO₂ + 0.289 Pt | | | | |
| Rh | 0.378 H₂O₂ + 0.244 Pt_{0.67}Rh_{0.33} → 0.054 Pt₃O₄ + | 3.098 | 0.426 | −0.420 | 0.915 |
| | 0.378 H₂O + 0.08 RhO₂ | | | | |
| Pd | 0.385 H₂O₂ + 0.23 Pd_{0.33}Pt_{0.67} → 0.154 PtO₂ + 0.076 | 3.348 | 0.394 | −0.381 | 0.830 |
| | PdO + 0.385 H₂O | | | | |
| Ag | 0.364 H₂O₂ + 0.272 Ag_{0.33}Pt_{0.67} → 0.182 PtO₂ + | 2.676 | 0.493 | −0.360 | 0.784 |
| | 0.364 H₂O + 0.09 Ag | | | | |
| Sn | 0.431 Sn_{0.33}Pt_{0.67} + 0.2845 H₂O₂ → 0.142 SnO₂ + | 1.320 | 1.000 | −0.515 | 1.122 |
| | 0.284 H₂O + 0.289 Pt | | | | |
| Sb | 0.2845 H₂O₂ + 0.431 Sb_{0.33}Pt_{0.67} → 0.142 SbO₂ + | 1.320 | 1.000 | −0.480 | 1.046 |
| | 0.284 H₂O + 0.289 Pt | | | | |
| Ce | 0.431 Ce_{0.33}Pt_{0.67} + 0.2845 H₂O₂ → 0.284 H₂O + | 1.320 | 1.000 | −0.851 | 1.854 |
| | 0.142 CeO₂ + 0.289 Pt | | | | |
| Hf | 0.2845 H₂O₂ + 0.431 Hf_{0.33}Pt_{0.67} → 0.284 H₂O + | 1.320 | 1.000 | −0.851 | 1.854 |
| | 0.142 HfO₂ + 0.289 Pt | | | | |
| Ta | 0.3115 H₂O₂ + 0.377 Ta_{0.33}Pt_{0.67} → 0.311 H₂O + | 1.653 | 0.799 | −0.790 | 1.721 |
| | 0.062 Ta₂O₅ + 0.253 Pt | | | | |
| W | 0.336 Pt_{0.67}W_{0.33} + 0.332 H₂O₂ → 0.111 WO₃ + 0.332 | 1.976 | 0.668 | −0.577 | 1.257 |
| | H₂O + 0.225 Pt | | | | |
| Re | 0.332 H₂O₂ + 0.336 Re_{0.33}Pt_{0.67} → 0.332 H₂O + 0.111 | 1.976 | 0.668 | −0.616 | 1.342 |
| | ReO₃ + 0.225 Pt | | | | |
| Os | 0.3625 H₂O₂ + 0.275 Os_{0.33}Pt_{0.67} → 0.091 OsO₄ + | 2.636 | 0.501 | −0.474 | 1.033 |
| | 0.363 H₂O + 0.184 Pt | | | | |
| Ir | 0.378 H₂O₂ + 0.244 Ir_{0.33}Pt_{0.67} → 0.054 Pt₃O₄ + 0.08 | 3.098 | 0.426 | −0.426 | 0.928 |
| | IrO2 + 0.378 H₂O | | | | |
| Au | 0.364 H₂O₂ + 0.272 Pt_{0.67}Au_{0.33} → 0.182 PtO₂ + | 2.676 | 0.493 | −0.365 | 0.795 |
| | 0.364 H₂O + 0.09 Au | | | | |
| Tl | 0.3815 H₂O₂ + 0.237 Tl_{0.33}Pt_{0.67} → 0.027 Pt₃O₄ + | 3.219 | 0.410 | −0.432 | 0.941 |
| | 0.039 Tl2Pt2O7 + 0.381 H₂O | | | | |
| Bi | 0.349 H₂O₂ + 0.302 Bi_{0.33}Pt_{0.67} → 0.05 Bi₂Pt₂O₇ + | 2.311 | 0.571 | −0.468 | 1.020 |
| | 0.349 H₂O + 0.103 Pt | | | | |

Table 11 depicts information of the most stable decomposition reaction between each Pt_{0.67}M_{0.33} and O₂. Table 11 provides a reaction equation of the most stable decomposition reaction between each Pt_{0.67}M_{0.33} and O₂. Table 11 also provides a molar fraction between O₂ and each Pt_{0.67}M_{0.33} for each reaction. Information of the most stable decomposition reaction between Pt_{0.67}Ru_{0.33} and O₂ is used as a reference for comparison. Table 11 further provides a penalty point (e.g. PP6) regarding the molar fraction, where PP6 of 1.000 is assigned to the reference reaction between O₂ and Pt_{0.67}Ru_{0.33} (i.e. the molar fraction is 1.000). PP6 is calculated by dividing the molar fraction between O₂ and Pt_{0.67}Ru_{0.33} by the molar fraction between O₂ and each Pt_{0.67}M_{0.33} of each reaction. For example, since the molar fraction between O₂ and Pt_{0.67}Ti_{0.33} is 0.331, PP6 thus equals 1.000/0.331, which is about 3.030.

Table 11 also provides a reaction enthalpy (E, eV/atom) of the most stable decomposition reaction between each Pt_{0.67}M_{0.33} and O₂. Table 11 further provides a penalty point (e.g. PP7) regarding the reaction enthalpy, where PP7 of 1.000 is assigned to the reference reaction between O₂ and Pt_{0.67}Ru_{0.33} (i.e. −1.112 eV/atom). PP7 is calculated by dividing the reaction enthalpy between O₂ and each Pt_{0.67}M_{0.33} of each reaction by that between O₂ and Pt_{0.67}Ru_{0.33}. For example, since the reaction enthalpy of the reaction between O₂ and Pt_{0.67}Ti_{0.33} is −1.584 eV/atom, PP7 thus equals −1.584/−1.112, which is about 1.392.

If both the molar fraction between O₂ and Pt_{0.67}M_{0.33}, and the reaction enthalpy of the reaction between O₂ and Pt_{0.67}M_{0.33} are greater than those for Pt_{0.67}Ru_{0.33}, it may indicate that the Pt_{0.67}M_{0.33} may be more stable than Pt_{0.67}Ru_{0.33}. Otherwise, Pt_{0.67}M_{0.33} may be less stable than Pt_{0.67}Ru_{0.33}.

TABLE 11
Information of the most stable decomposition reaction between Pt_{0.67}M_{0.33} and O₂, where M may
be Ti, Ge, Se, Zr, Nb, Mo, Rh, Pd, Ag, Sn, Sb, Ce, Hf, Ta, W, Re, Os, Ir, Au, Tl, or Bi.

| | Equation of the most stable decomposition reaction | Molar | | E | |
|---|---|---|---|---|---|
| M | between Pt_{0.67}M_{0.33} and O₂ | fraction | PP6 | (eV/atom) | PP7 |
| Ru | 0.3335 O₂ + 0.333 Ru_{0.33}Pt_{0.67} → 0.223 PtO₂ + 0.11 RuO₂ | 1.000 | 1.000 | −1.112 | 1.000 |
| (reference) | | | | | |
| Ti | 0.199 O₂ + 0.602 Ti_{0.33}Pt_{0.67} → 0.199 TiO₂ + 0.404 Pt | 0.331 | 3.030 | −1.548 | 1.392 |
| Ge | 0.3335 O₂ + 0.333 Ge_{0.33}Pt_{0.67} → 0.223 PtO₂ + 0.11 GeO₂ | 1.000 | 1.002 | −1.192 | 1.072 |
| Se | 0.3335 O₂ + 0.333 Pt_{0.67}Se_{0.33} → 0.223 PtO₂ + 0.11 SeO₂ | 1.000 | 1.002 | −0.938 | 0.844 |
| Zr | 0.199 O₂ + 0.602 Zr_{0.33}Pt_{0.67} → 0.199 ZrO₂ + 0.404 Pt | 0.331 | 3.030 | −1.649 | 1.483 |
| Nb | 0.226 O₂ + 0.548 Nb_{0.33}Pt_{0.67} → 0.09 Nb₂O₅ + 0.367 Pt | 0.412 | 2.428 | −1.552 | 1.396 |
| Mo | 0.35 O₂ + 0.3 Mo_{0.33}Pt_{0.67} → 0.099 MoO₃ + 0.201 PtO₂ | 1.167 | 0.858 | −0.776 | 0.698 |
| Rh | 0.3335 O₂ + 0.333 Pt_{0.67}Rh_{0.33} → 0.223 PtO₂ + 0.11 RhO₂ | 1.000 | 1.002 | −1.032 | 0.928 |
| Pd | 0.3125 O₂ + 0.375 Pd_{0.33}Pt_{0.67} → 0.251 PtO₂ + 0.124 PdO | 0.833 | 1.202 | −0.891 | 0.801 |
| Ag | 0.3125 O₂ + 0.375 Ag_{0.33}Pt_{0.67} → 0.251 PtO₂ + 0.124 AgO | 0.833 | 1.202 | −0.804 | 0.723 |
| Sn | 0.3335 O₂ + 0.333 Sn_{0.33}Pt_{0.67} → 0.223 PtO₂ + 0.11 SnO₂ | 1.000 | 1.002 | −1.180 | 1.061 |
| Sb | 0.342 O₂ + 0.316 Sb_{0.33}Pt_{0.67} → 0.052 Sb₂O₅ + 0.212 PtO₂ | 1.082 | 0.925 | −1.143 | 1.028 |
| Ce | 0.199 O₂ + 0.602 Ce_{0.33}Pt_{0.67} → 0.199 CeO₂ + 0.404 Pt | 0.331 | 3.030 | −1.735 | 1.560 |
| Hf | 0.199 O₂ + 0.602 Hf_{0.33}Pt_{0.67} → 0.404 Pt + 0.199 HfO₂ | 0.331 | 3.030 | −1.736 | 1.561 |
| Ta | 0.226 O₂ + 0.548 Ta_{0.33}Pt_{0.67} → 0.09 Ta₂O₅ + 0.367 Pt | 0.412 | 2.428 | −1.713 | 1.540 |
| W | 0.3265 O₂ + 0.347 Pt_{0.67}W_{0.33} → 0.077 Pt₃O₄ + 0.114 WO₃ | 0.941 | 1.064 | −1.333 | 1.199 |
| Re | 0.3265 O₂ + 0.347 Re_{0.33}Pt_{0.67} → 0.077 Pt₃O₄ + 0.114 ReO₃ | 0.941 | 1.064 | −1.400 | 1.259 |
| Os | 0.3635 O₂ + 0.273 Os_{0.33}Pt_{0.67} → 0.09 OsO₄ + 0.183 PtO₂ | 1.332 | 0.752 | −1.209 | 1.087 |
| Ir | 0.3335 O₂ + 0.333 Ir_{0.33}Pt_{0.67} → 0.223 PtO₂ + 0.11 IrO₂ | 1.001 | 1.000 | −1.047 | 0.942 |
| Au | 0.2865 O₂ + 0.427 Pt_{0.67}Au_{0.33} → 0.286 PtO₂ + 0.141 Au | 0.671 | 1.493 | −0.805 | 0.724 |
| Tl | 0.3235 O₂ + 0.353 Tl_{0.33}Pt_{0.67} → 0.12 PtO₂ + 0.058 Tl₂Pt₂O₇ | 0.916 | 1.093 | −1.050 | 0.944 |
| Bi | 0.327 O₂ + 0.346 Bi_{0.33}Pt_{0.67} → 0.118 PtO₂ + 0.038 Bi₃Pt₃O₁₁ | 0.945 | 1.060 | −1.132 | 1.018 |

Based on the information provided in Tables 8 to 11, a sum of the penalty points (ΣPP) is calculated for each Pt_{0.67}M_{0.33}, i.e., ΣPP=PP1+PP2+PP3+PP4+PP5+PP6+PP7. The sum of the penalty points for Pt_{0.67}Ru_{0.33} is 6.330, i.e. ΣPP (Pt_{0.67}Ru_{0.33})=6.330. Table 12 provides a summary of the information in relation to each Pt_{0.67}M_{0.33}. Particularly, Table 12 provides a sum of the penalty points (ΣPP) for each Pt_{0.67}M_{0.33}. Table 12 further provides the molecular weight (MW) of each Pt_{0.67}M_{0.33}, a sum of penalty points of each Pt_{0.67}M_{0.33} per MW (ΣPP per MW), and a percentage (%) of improvement of each Pt_{0.67}M_{0.33} when compared to Pt_{0.67}Ru_{0.33} based on the ΣPP per MW. It is noted that 1PP (Pt_{0.67}Ru_{0.33}) per MW is about 38.585. To calculate the percentage of improvement of each Pt_{0.67}Ru_{0.33} when compared to Pt_{0.67}Ru_{0.33} based on the ΣPP per MW, ΣPP (Pt_{0.67}Ru_{0.33}) per MW is divided by the ΣPP per MW of each Pt_{0.67}M_{0.33}. For example, since 1PP (Pt_{0.67}Ti_{0.33}) per MW 82.505, the percentage of improvement of Pt_{0.67}Ti_{0.33} when compared to Pt_{0.67}Ru_{0.33} thus equals 38.585/82.505, which is about 46.8%.

TABLE 12
A summary of the information in relation to each Pt_{0.67}M_{0.33},
where M may be Ti, Ge, Se, Zr, Nb, Mo, Rh, Pd, Ag, Sn, Sb,
Ce, Hf, Ta, W, Re, Os, Ir, Au, Tl, or Bi.

| | | | | % of |
|---|---|---|---|---|
| | | MW | ΣPP per | improvement |
| M | ΣPP | (g/mol) | MW (mg) | per MW (g) |
| Ru | 6.330 | 164.055 | 38.585 | 100.0 |
| (reference) | | | | |
| Ti | 12.087 | 146.498 | 82.505 | 46.8 |
| Ge | 7.304 | 154.673 | 47.219 | 81.7 |
| Se | 4.876 | 156.759 | 31.106 | 124.0 |
| Zr | 12.389 | 160.806 | 77.041 | 50.1 |
| Nb | 11.469 | 161.361 | 71.077 | 54.3 |
| Mo | 7.435 | 162.362 | 45.791 | 84.3 |
| Rh | 5.971 | 164.661 | 36.260 | 106.4 |
| Pd | 5.473 | 165.821 | 33.008 | 116.9 |
| Ag | 6.052 | 166.299 | 36.392 | 106.0 |
| Sn | 6.759 | 169.877 | 39.788 | 97.0 |
| Sb | 6.513 | 170.883 | 38.111 | 101.2 |
| Ce | 11.959 | 176.941 | 67.586 | 57.1 |
| Hf | 12.644 | 189.604 | 66.687 | 57.9 |
| Ta | 11.128 | 190.415 | 58.443 | 66.0 |
| W | 7.995 | 191.369 | 41.776 | 92.4 |
| Re | 7.429 | 192.151 | 38.661 | 99.8 |
| Os | 5.464 | 193.478 | 28.239 | 136.6 |
| Ir | 5.342 | 194.134 | 27.518 | 140.2 |
| Au | 5.760 | 195.701 | 29.430 | 131.1 |
| Tl | 5.670 | 198.149 | 28.613 | 134.8 |
| Bi | 6.167 | 199.666 | 30.885 | 124.9 |

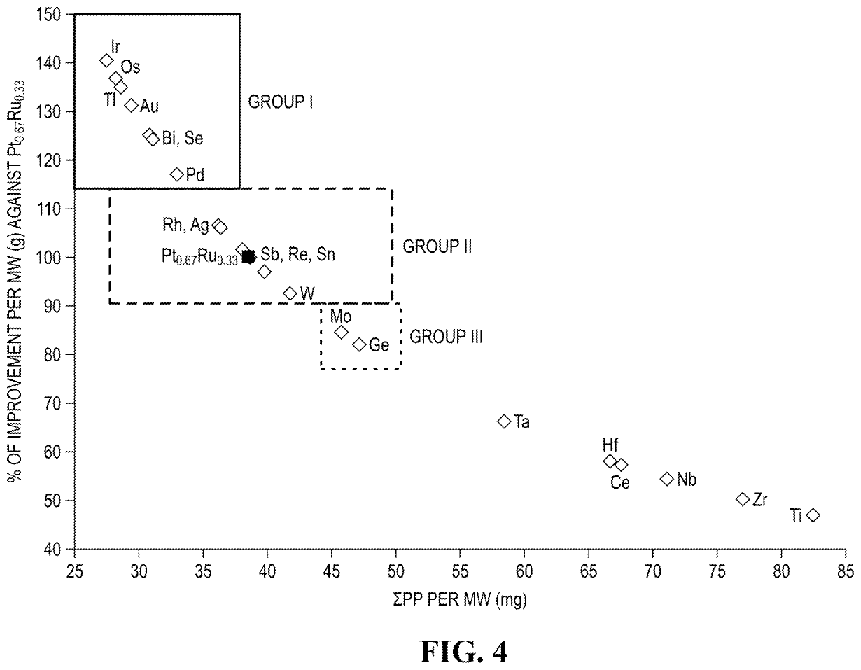

FIG. 4 depicts a schematic diagram depicting a summary representation of several Pt_{0.67}M_{0.33} alloys. Specifically, FIG. 4 depicts a schematic diagram of a percentage (%) of improvement of each Pt_{0.67}M_{0.33} when compared to Pt_{0.67}Ru_{0.33} based on the ΣPP per MW as a function of a sum of penalty points of each Pt_{0.67}M_{0.33} per MW (ΣPP per MW).

Referring to FIG. 4, there are three groups of Pt_{0.67}M_{0.33} that may be suitable to be used as electrochemical cell anode catalyst materials to prevent cell voltage reversal during H₂ fuel starvation. Group I includes Pt_{0.67}M_{0.33}, where M may be Ir, Os, Tl, Au, Bi, Se, or Pd. These Pt-based alloy appear to be less chemically reactive than Pt_{0.67}Ru_{0.33} in an oxidizing environment (e.g. against O₂, H₂O₂, and/or HO₂), thus more stable than Pt_{0.67}Ru_{0.33}. Among these metal elements, Os, Tl, Au, and Pd are relatively more expensive. Group II includes Pt_{0.67}M_{0.33}, where M may be Rh, Ag, Sb, Re, Sn, or W. These Pt-based alloys appear to exhibit similar chemical reactivities as Pt_{0.67}Ru_{0.33} in an oxidizing environment (e.g. against O₂, H₂O₂, and/or HO₂). Among these metal elements, Rh is relatively more expensive. Group III includes Pt_{0.67}M_{0.33}, where M may be Mo or Ge. These two Pt-based alloys appear to be slightly more reactive than Pt_{0.67}Ru_{0.33} in an oxidizing environment (e.g. against O₂, H₂O₂, and/or HO₂). In one or more embodiments, any Pt_{0.67}M_{0.33} in Groups I, II and III may be combined to be used as electrochemical cell anode catalyst materials to prevent cell voltage reversal during H₂ fuel starvation. Lastly, Group IV includes Pt_{0.67}M_{0.33}, where M may be Ta, Hf, Ce, Nb, Zr, or Ti. These Pt-based alloys appear to be too active and least stable in an oxidizing environment (e.g. against O₂, H₂O₂, and/or HO₂).

Noted that Pt-M alloys having ratios of Pt to M other than 2 may similarly be evaluated using the method described herein. For instance, in some other embodiments, the data-driven materials screening method may be utilized to evaluate Pt-M alloys, such as Pt_{0.95}M_{0.05} or Pt_{0.5}M_{0.5}, where M may be Ti, Ge, Se, Zr, Nb, Mo, Ru, Rh, Pd, Ag, Sn, Sb, Ce, Hf, Ta, W, Re, Os, Ir, Au, Tl, or Bi, to identify those suitable to be used as electrochemical cell anode catalyst materials to prevent cell voltage reversal during H₂ fuel starvation.

Apart from binary Pt-based alloys, the data-driven materials screening method may further be used to screen ternary Pt-based alloys, i.e. Pt-M^{I}-M¹¹, to identify those that are suitable to be used as electrochemical cell anode catalyst materials to prevent cell voltage reversal during H₂ fuel starvation. M^{I} is a metal element other than Pt, and M^{II} is also a metal element other than Pt. In some embodiments, the ternary Pt-based alloys may be PtₓM^{I}_{y}M^{II}z, where x=2y=6z, x>0, M^{I} may be Ru, Ge, or Mo, and M^{II} may be Ir, Os, Tl, Au, Bi, Se, or Pd. For example, the ternary Pt-based alloys are Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-based alloys may be PtₓM^{I}_{y}M^{II}_{z}, where x=6y=2z, x>0, M^{I} may be Ru, Ge, or Mo, and M^{II} may be Ir, Os, Tl, Au, Bi, Se, or Pd. For example, the ternary Pt-based alloys are Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Ti, Au, Bi, Se, or Pd.

Table 13 provides a summary of information of some exemplary Pt-M^{I}-M^{II}. Table 13 provides a sum of penalty points (ΣPP′) for each Pt-M^{I}-M¹¹. Table 13 further provides the molecular weight (MW) of each Pt-M^{I}-M^{II}, a sum of penalty points of each Pt-M^{I}-M^{II} per MW (ΣPP′ per MW), and a percentage (%) of improvement of each Pt-M^{I}-M^{II} when compared to Pt_{0.67}Ru_{0.33} based on the ΣPP′ per MW. It is noted that 1PP (Pt_{0.67}Ru_{0.33}) per MW is about 38.585. To calculate the percentage of improvement of each Pt-M^{I}-M^{II} when compared to Pt_{0.67}Ru_{0.33} based on the ΣPP′ per MW, ΣPP (Pt_{0.67}Ru_{0.33}) per MW is divided by the ΣPP′ per MW of each Pt-M^{I}-M¹¹. For example, since 1PP′ (Pt_{0.6}Ru_{0.3}Ir_{0.1}) per MW 35.841, the percentage of improvement of Pt_{0.6}Ru_{0.3}Ir_{0.1} when compared to Pt_{0.67}Ru_{0.33} thus equals 38.585/35.841, which is about 107.7%.

TABLE 13
A summary of information of exemplary Pt-M^{I}-M^{II}.

| | | | | % of |
|---|---|---|---|---|
| | | MW | ΣPP′ per | improvement |
| Composition | ΣPP′ | (g/mol) | MW (mg) | per MW (g) |
| Ru (reference) | 6.330 | 164.055 | 38.585 | 100.0 |
| Pt_{0.6}Ru_{0.3}Ir_{0.1} | 5.971 | 166.590 | 35.841 | 107.7 |
| Pt_{0.6}Ge_{0.3}Se_{0.1} | 7.317 | 146.735 | 49.865 | 77.4 |
| Pt_{0.6}Ge_{0.3}Bi_{0.1} | 8.440 | 159.737 | 52.839 | 73.0 |
| Pt_{0.6}Mo_{0.3}Se_{0.1} | 8.095 | 153.725 | 52.662 | 73.3 |
| Pt_{0.6}Mo_{0.3}Bi_{0.1} | 8.823 | 166.727 | 52.919 | 72.9 |
| Pt_{0.6}Ge_{0.1}Se_{0.3} | 5.939 | 147.999 | 40.129 | 96.2 |
| Pt_{0.6}Ge_{0.1}Bi_{0.3} | 8.386 | 187.005 | 44.846 | 86.0 |
| Pt_{0.6}Mo_{0.1}Se_{0.3} | 6.126 | 150.329 | 40.751 | 94.7 |
| Pt_{0.6}Mo_{0.1}Bi_{0.3} | 7.709 | 189.335 | 40.718 | 94.8 |

In view of the foregoing, Pt-based alloys that are comparatively effective as Pt—Ru to be used as electrochemical cell anode catalyst materials may be a binary Pt-M alloy, where M may be Ge, Se, Mo, Rh, Pd, Ag, Sn, Sb, W, Re, Os, Ir, Au, Tl or Bi. In some embodiments, the binary Pt-M alloy may be PtₓM_{y}, where x=2y, x>0, and M may be Ge, Se, Mo, Rh, Pd, Ag, Sn, Sb, W, Re, Os, Ir, Au, Tl or Bi. For example, the binary Pt-M alloy is Pt_{0.67}M_{0.33}, where M may be Ge, Se, Mo, Rh, Pd, Ag, Sn, Sb, W, Re, Os, Ir, Au, Ti or Bi. In some other embodiments, the binary Pt-M alloy may be Pt_{0.95}M_{0.05}, where M may be Ge, Se, Mo, Rh, Pd, Ag, Sn, Sb, W, Re, Os, Ir, Au, Ti or Bi. In yet some other embodiments, the binary Pt-M alloy may be Pt_{0.5}M_{0.5}, where M may be Ge, Se, Mo, Rh, Pd, Ag, Sn, Sb, W, Re, Os, Ir, Au, Ti or Bi.

The Pt-based alloys may also be a ternary Pt-M^{I}-M^{II} alloy, where M^{I} is a metal element other than Pt, and M^{II} is also a metal element other than Pt. In some embodiments, the ternary Pt-M^{I}-M^{II} alloy may be PtₓM^{I}_{y}M^{II}_{z}, where x=2y=6z, x>0, M^{I} may be Ru, Ge, or Mo, and Mu may be Ir, Os, Tl, Au, Bi, Se, or Pd. For example, the ternary Pt-M^{I}-M^{II} alloy is Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-M^{I}-M^{II} alloy may be PtₓM^{I}_{y}M^{II}_{z}, where x=6y=2z, x>0, M^{I} may be Ru, Ge, or Mo, and M may be Ir, Os, Tl, Au, Bi, Se, or Pd. For example, the ternary Pt-M^{I}-M^{II} alloy is Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd.

Either the binary or ternary Pt-based alloys may further be mixed with Ir, Ru and/or an Ir—Ru alloy. Either the binary or ternary Pt-based alloys may also be mixed with Ir- or Ru-containing oxides, such as IrO₂, RuO₂, and/or Ir—Ru—O. Ir—Ru—O is a metal oxide of Ir and Ru.

To synthesize a Pt-based alloy catalyst, Pt may be annealed with stoichiometric amounts of other metal element precursors under a reducing heat treatment condition (e.g. under a nitrogen (N₂), argon (Ar), or H₂ gas atmosphere). Depending on the alloy, a heat treatment temperature may be in a range of 150 and 1,000° C., and a heat treatment time may be in a range of 30 seconds and 24 hours.

The loss of ECSA of a Pt-based alloy catalyst may be determined using a potentiostat with either a triangular or square wave having a voltage up to 0.9 V. In some embodiments, to understand catalyst degradation induced by carbon corrosion, the voltage may be further up to 1.5 V. When determining the loss of ECSA, H₂ may be used to measure an amount of the adsorbed or desorbed gas. For a more accurate determination of the loss of ECSA, a carbon monoxide stripping method may be utilized. In addition, mass activity measurements of the Pt-based alloy catalyst may be performed in a rotating disk electrode (RDE) or using a full membrane-electrode-assembly (MEA) setup under H₂ or O₂ atmosphere.

Referring back to FIG. 1, the anode layer 14 may include an anode catalyst support and an anode catalyst material supported on the anode catalyst support. The anode catalyst material may include a Pt-based alloy. The Pt-based alloy may be a binary Pt-M alloy, where M may be Ge, Se, Mo, Rh, Pd, Ag, Sn, Sb, W, Re, Os, Ir, Au, Tl or Bi. In some embodiments, the binary Pt-M alloy may be PtₓM_{y}, where x=2y, x>0, and M may be Ge, Se, Mo, Rh, Pd, Ag, Sn, Sb, W, Re, Os, Ir, Au, Tl or Bi. For example, the binary Pt-M alloy is Pt_{0.67}M_{0.33}, where M may be Ge, Se, Mo, Rh, Pd, Ag, Sn, Sb, W, Re, Os, Ir, Au, Tl or Bi. In some other embodiments, the binary Pt-M alloy may be Pt_{0.95}M_{0.05}, where M may be Ge, Se, Mo, Rh, Pd, Ag, Sn, Sb, W, Re, Os, Ir, Au, Tl or Bi. In yet some other embodiments, the binary Pt-M alloy may be Pt_{0.5}M_{0.5}, where M may be Ge, Se, Mo, Rh, Pd, Ag, Sn, Sb, W, Re, Os, Ir, Au, Tl or Bi.

The Pt-based alloy may also be a ternary Pt-M^{I}-M^{II} alloy, where M^{I} is a metal element other than Pt, and M^{II} is also a metal element other than Pt. In some embodiments, the ternary Pt-M^{I}-M^{II} alloy may be PtₓM^{I}_{y}M^{II}_{z}, where x=2y=6z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-M^{I}-M^{II} alloy may be PtₓM^{I}_{y}M^{II}_{z}, where x=6y=2z, x>0, M^{I} may be Ru, Ge, or Mo, and M may be Ir, Os, Tl, Au, Bi, Se, or Pd. For example, the ternary Pt-M^{I}-M^{II} alloy is Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd.

Either the binary or ternary Pt-based alloys may also be mixed with Ir- or Ru-containing oxides, such as IrO₂, RuO₂, and/or Ir—Ru—O. Ir—Ru—O is a metal oxide of Ir and Ru. Either the binary or ternary Pt-based alloys may be nanoparticles having an average size in a range of 1 and 20 nm.

Continuing referring to FIG. 1, the anode catalyst material is supported on a catalyst support. For example, the anode catalyst material may be mixed with the catalyst support. Alternatively, the anode catalyst material may be coated onto the catalyst support. The catalyst support may be carbon black, fibrous carbon, graphite, graphene, graphene oxide, reduced graphene oxide, defective graphene, defected graphite, graphyne, titanium oxide (TiO, Ti₂O₃, or TiO₂), tin oxide (SnO or SnO₂), molybdenum oxide (MoOₓ, 0≤x≤3), niobium oxide (Nb₂O₅), magnesium titanium oxide (MgTi₂O₅₋ₓ, 0≤x≤5), titanium-tin oxide (TiSnOₓ, 0≤x≤4), or a combination thereof.

Individual PEM fuel cells may be assembled into a fuel cell stack. Each fuel cell in the stack is sandwiched between two flow field plates which separate each fuel cell from neighboring fuel cells. In a fuel cell stack, cell voltages of individual fuel cells may be different depending on the location of each fuel cell in the fuel cell stack. Different cell voltages may induce different degradations upon the catalyst performance in each fuel cell. For example, fuel cells that are positioned near a reactant inlet of the fuel cell stack may degrade faster than the ones positioned in a middle area of the fuel cell stack. Therefore, to improve the performance and durability of a fuel cell stack, catalyst materials of a PEM fuel cell may be varied based on its location in the fuel cell stack.

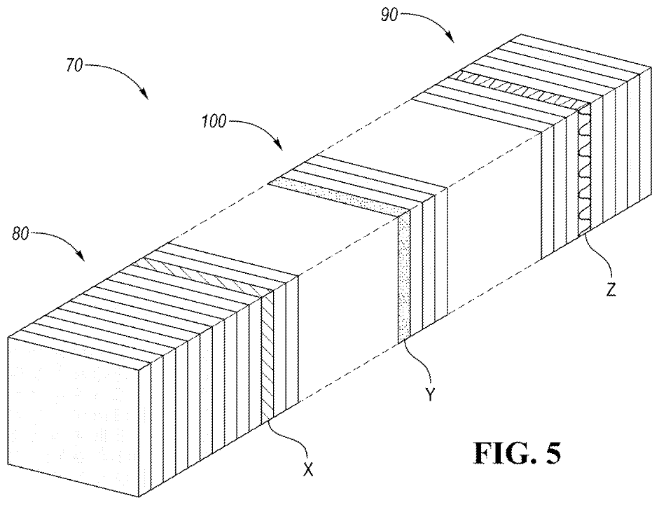

FIG. 5 depicts a schematic perspective view of a fuel cell stack according to one or more embodiments of the present disclosure. The fuel cell stack 70 may include three regions, where each region includes at least one fuel cell having an MEA with a catalyst material. Based on the locations of each fuel cell in the fuel cell stack, the catalyst material may vary. For example, if an area is more susceptible to catalyst degradation, catalyst materials that have superior durability (i.e., difficult to dissolve or degrade) may be applied to the fuel cells located in that area. Further, if an area is expected to operate in a steady state, catalyst materials that exhibit robust catalytic activity may be selected to fabricate MEAS of the fuel cells located in the area.

Referring to FIG. 5, the fuel cell stack 70 may include a first region 80, a second region 90, and a third region 100. The first region 80 may be adjacent to a first reactant inlet, such as Hz. The second region 90 may be adjacent to a second reactant inlet, such as O₂ or air. The third region 100 is situated between the first and second regions 60 and 70.

At least one fuel cell, for example, fuel cell X, in the first region 80 may include an MEA with a first anode catalyst material on an anode layer of the fuel cell X. Similarly, at least one fuel cell, for example, fuel cell Z, in the second region 90 may include an MEA with a second anode catalyst material on an anode layer of the fuel cell Z. Likewise, at least one fuel cell, for example, fuel cell Y, in the third region 100 may include an MEA with a third anode catalyst material on an anode layer of the fuel cell Y. According to the locations of fuel cells X, Y and Z in the fuel cell stack 70, at least one of the first, second, and third anode catalyst materials are different.

To prevent cell voltage reversal during H₂ fuel starvation, the first anode catalyst material in fuel cell X may include a first Pt-based alloy. The first Pt-based alloy may be a binary Pt-M alloy, where M may be Ge, Se, Mo, Rh, Pd, Ag, Sn, Sb, W, Re, Os, Ir, Au, Tl or Bi. In some embodiments, the binary Pt-M alloy may be PtₓM_{y}, where x=2y, x>0, and M may be Ge, Se, Mo, Rh, Pd, Ag, Sn, Sb, W, Re, Os, Ir, Au, Tl or Bi. For example, the binary Pt-M alloy is Pt_{0.67}M_{0.33}, where M may be Ge, Se, Mo, Rh, Pd, Ag, Sn, Sb, W, Re, Os, Ir, Au, Tl or Bi. In some other embodiments, the binary Pt-M alloy may be Pt_{0.95}M_{0.05}, where M may be Ge, Se, Mo, Rh, Pd, Ag, Sn, Sb, W, Re, Os, Ir, Au, Tl or Bi. In yet some other embodiments, the binary Pt-M alloy may be Pt_{0.5}M_{0.5}, where M may be Ge, Se, Mo, Rh, Pd, Ag, Sn, Sb, W, Re, Os, Ir, Au, Tl or Bi. The first Pt-based alloy may also be a ternary Pt-M^{I}-M^{II} alloy. In some embodiments, the ternary Pt-M^{I}-M^{II} alloy may be PtₓM^{I}_{y}M^{II}_{z}, where x=2y=6z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-M^{I}-M^{II} alloy may be PtₓM^{I}_{y}M^{II}_{z}, where x=6y=2z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd. The first Pt-based alloy may further be mixed with Ir, Ru and/or an Ir—Ru alloy. The first Pt-based alloy may also be mixed with Ir- or Ru-containing oxides, such as IrO₂, RuO₂, and/or Ir—Ru—O. Ir—Ru—O is a metal oxide of Ir and Ru. The first Pt-based alloy may be a nanoparticle having an average size in a range of 1 and 20 nm.

The second anode catalyst material in fuel cell Z may include a second Pt-based alloy. The second Pt-based alloy may be a binary Pt-M alloy, where M may be Ge, Se, Mo, Rh, Pd, Ag, Sn, Sb, W, Re, Os, Ir, Au, Ti or Bi. In some embodiments, the binary Pt-M alloy may be PtₓM_{y}, where x=2y, x>0, and M may be Ge, Se, Mo, Rh, Pd, Ag, Sn, Sb, W, Re, Os, Ir, Au, Ti or Bi. For example, the binary Pt-M alloy is Pt_{0.67}M_{0.33}, where M may be Ge, Se, Mo, Rh, Pd, Ag, Sn, Sb, W, Re, Os, Ir, Au, Ti or Bi. In some other embodiments, the binary Pt-M alloy may be Pt_{0.95}M_{0.05}, where M may be Ge, Se, Mo, Rh, Pd, Ag, Sn, Sb, W, Re, Os, Ir, Au, Ti or Bi. In yet some other embodiments, the binary Pt-M alloy may be Pt_{0.5}M_{0.5}, where M may be Ge, Se, Mo, Rh, Pd, Ag, Sn, Sb, W, Re, Os, Ir, Au, Ti or Bi. The second Pt-based alloy may also be a ternary Pt-M^{I}-M^{II} alloy. In some embodiments, the ternary Pt-M^{I}-M^{II} alloy may be PtₓM^{I}_{y}M^{II}_{z}, where x=2y=6z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-M^{I}-M^{II} alloy may be PtₓM^{I}_{y}M^{II}_{z}, where x=6y=2z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Ti, Au, Bi, Se, or Pd. The second Pt-based alloy may further be mixed with Ir, Ru and/or an Ir—Ru alloy. The second Pt-based alloy may also be mixed with Ir- or Ru-containing oxides, such as IrO₂, RuO₂, and/or Ir—Ru—O. Ir—Ru—O is a metal oxide of Ir and Ru. The second Pt-based alloy may be a nanoparticle having an average size in a range of 1 and 20 nm.

The third anode catalyst material in fuel cell Y may include a third Pt-based alloy. The third Pt-based alloy may be a binary Pt-M alloy, where M may be Ge, Se, Mo, Rh, Pd, Ag, Sn, Sb, W, Re, Os, Ir, Au, Ti or Bi. In some embodiments, the binary Pt-M alloy may be PtₓM_{y}, where x=2y, x>0, and M may be Ge, Se, Mo, Rh, Pd, Ag, Sn, Sb, W, Re, Os, Ir, Au, Ti or Bi. For example, the binary Pt-M alloy is Pt_{0.67}M_{0.33}, where M may be Ge, Se, Mo, Rh, Pd, Ag, Sn, Sb, W, Re, Os, Ir, Au, Ti or Bi. In some other embodiments, the binary Pt-M alloy may be Pt_{0.95}M_{0.05}, where M may be Ge, Se, Mo, Rh, Pd, Ag, Sn, Sb, W, Re, Os, Ir, Au, Ti or Bi. In yet some other embodiments, the binary Pt-M alloy may be Pt_{0.5}M_{0.5}, where M may be Ge, Se, Mo, Rh, Pd, Ag, Sn, Sb, W, Re, Os, Ir, Au, Ti or Bi. The third Pt-based alloy may also be a ternary Pt-M^{I}-M^{II} alloy. In some embodiments, the ternary Pt-M^{I}-M^{II} alloy may be PtₓM^{I}_{y}M^{II}_{z}, where x=2y=6z, x>0, M^{I} may be Ru, Ge, or Mo, and M^{II} may be Ir, Os, Tl, Au, Bi, Se, or Pd. For example, the ternary Pt-M^{I}-M^{II} alloy is Pt_{0.6}M^{I}_{0.3}M^{II}_{0.1}, where M^{I} may be Ru, Ge, or Mo, and M^{II} may be Ir, Os, Tl, Au, Bi, Se, or Pd. In some other embodiments, the ternary Pt-M^{I}-M^{II} alloy may be PtₓM^{I}_{y}M^{II}_{z}, where x=6y=2z, x>0, M^{I} may be Ru, Ge, or Mo, and M^{II} may be Ir, Os, Tl, Au, Bi, Se, or Pd. For example, the ternary Pt-alloy is Pt_{0.6}M^{I}_{0.1}M^{II}_{0.3}, where M^{I} may be Ru, Ge, or Mo, and M^{II} may be Ir, Os, Tl, Au, Bi, Se, or Pd. In yet some other embodiments, the ternary Pt-based alloys may be PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd. The third Pt-based alloy may further be mixed with Ir, Ru and/or an Ir—Ru alloy. The third Pt-based alloy may also be mixed with Ir- or Ru-containing oxides, such as IrO₂, RuO₂, and/or Ir—Ru—O. Ir—Ru—O is a metal oxide of Ir and Ru. The third Pt-based alloy may be a nanoparticle having an average size in a range of 1 and 20 nm.

Continuing referring to FIG. 5, each of the first, second and third anode catalyst materials is supported on a catalyst support. For example, each of the first, second and third anode catalyst materials may be mixed with the catalyst support. Alternatively, each of the first, second and third anode catalyst materials may be coated onto the catalyst support. The catalyst support may be carbon black, fibrous carbon, graphite, graphene, graphene oxide, reduced graphene oxide, defective graphene, defected graphite, graphyne, titanium oxide (TiO, Ti₂O₃, or TiO₂), tin oxide (SnO or SnO₂), molybdenum oxide (MoOₓ, 0<x<3), niobium oxide (Nb₂O₅), magnesium titanium oxide (MgTi₂O₅₋ₓ, 0<x<5), titanium-tin oxide (TiSnOₓ, 0<x<4), or a combination thereof.

In addition to catalyst materials, catalyst loadings may also influence catalytic activities of a fuel cell stack. High catalyst loadings may extend a lifetime of the fuel cell stack and consequently boost the fuel cell stack performance. On the other hand, low catalyst loadings may accelerate catalyst consumption and affect fuel cell performance. Therefore, besides varying the anode catalyst materials according to the locations of the fuel cells in the fuel cell stack, dynamically allocating catalyst loadings in the fuel cells according to the locations of the fuel cells in the fuel cell stack may further improve the performance and durability of the fuel cell stack.

Apart from catalyst materials and catalyst loadings, other factors may also influence the performance and durability of the fuel cell stack. Some of these factors may include ionomers used in the MEAS of the fuel cells in the fuel cell stack. Therefore, varying the ionomers in the fuel cells based on the locations of the fuel cells in the fuel cell stack may also improve the performance and durability of the fuel cell stack.

Noted that a catalyst support, such as an anode catalyst support, may not be required for some types of electrochemical cells, such as electrolyzers.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An anode catalyst layer of an electrochemical cell comprising:
an anode catalyst material, the anode catalyst material being a Pt-based alloy, the Pt-based alloy being a binary Pt-M alloy, where M is Ge, Se, Ag, Sb, Os, or Tl.

2. The anode catalyst layer of the electrochemical cell of claim 1, wherein the binary Pt-M alloy is PtₓM_{y}, where x=2y, x>0, and M is Ge, Se, Ag, Sb, Os, or Tl.

3. The anode catalyst layer of the electrochemical cell of claim 1, wherein the binary Pt-M alloy is Pt_{0.95}M_{0.05}, where M is Ge, Se, Ag, Sb, Os, or Tl.

4. The anode catalyst layer of the electrochemical cell of claim 1, wherein the binary Pt-M alloy is Pt_{0.5}M_{0.5}, where M is Ge, Se, Ag, Sb, Os, or Tl.

5. The anode catalyst layer of the electrochemical cell of claim 1, wherein the binary Pt-M alloy is mixed with Ir, Ru, an Ir—Ru alloy, IrO₂, RuO₂, and/or Ir—Ru—O.

6. The anode catalyst layer of the electrochemical cell of claim 1, wherein the binary Pt-M alloy is a nanoparticle having an average size in a range of 1 to 20 nm.

7. An anode catalyst layer of an electrochemical cell comprising:
an anode catalyst material, the anode catalyst material being a Pt-based alloy, the Pt-based alloy being a ternary Pt-M^{I}-M^{II} alloy, where M^{I} is Ru, Ge, or Mo, and M^{II} is Ir, Os, Tl, Au, Bi, Se, or Pd.

8. The anode catalyst layer of the electrochemical cell of claim 7, wherein the ternary Pt-M^{I}-M^{II} alloy is PtₓM^{I}_{y}M^{II}_{z}, where x=2y=6z, x>0, M^{I} is Ru, Ge, or Mo, and M^{II} is Ir, Os, Tl, Au, Bi, Se, or Pd.

9. The anode catalyst layer of the electrochemical cell of claim 7, wherein the ternary Pt-M^{I}-M^{II} alloy is PtₓM^{I}_{y}M^{II}_{z}, where x=6y=2z, x>0, M^{I} is Ru, Ge, or Mo, and M^{II} is Ir, Os, Tl, Au, Bi, Se, or Pd.

10. The anode catalyst layer of the electrochemical cell of claim 7, wherein the ternary Pt-M^{I}-M^{II} alloy is PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd.

11. The anode catalyst layer of the electrochemical cell of claim 7, wherein the ternary Pt-M^{I}-M^{II} alloy is mixed with Ir, Ru, an Ir—Ru alloy, IrO₂, RuO₂, and/or Ir—Ru—O.

12. The anode catalyst layer of the electrochemical cell of claim 7, wherein the Pt-based alloy is a nanoparticle having an average size in a range of 1 to 20 nm.

13. An electrochemical cell comprising:
an anode catalyst layer having an anode catalyst material, the anode catalyst material being a Pt-based alloy, the Pt-based alloy being a binary Pt-M alloy, where M is Ge, Se, Ag, Sb, Os or Tl; or being a ternary Pt-M^{I}-M^{II} alloy, where M^{I} is Ru, Ge, or Mo, and M^{II} is Ir, Os, Tl, Au, Bi, Se, or Pd;
a cathode catalyst layer; and
an electrolyte membrane situated between the anode and cathode catalyst layers.

14. The electrochemical cell of claim 13, wherein the binary Pt-M alloy is PtₓM_{y}, where x=2y, x>0, and M is Ge, Se, Ag, Sb, Os, or Tl.

15. The electrochemical cell of claim 13, wherein the binary Pt-M alloy is Pt_{0.95}M_{0.05}, where M is Ge, Se, Ag, Sb, Os, or Tl.

16. The electrochemical cell of claim 13, wherein the binary Pt-M alloy is Pt_{0.5}M_{0.5}, where M is Ge, Se, Ag, Sb, Os, or Tl.

17. The electrochemical cell of claim 13, wherein the ternary Pt-M^{I}-M^{II} alloy is PtₓM^{I}_{y}M^{II}_{z}, where x=2y=6z, x>0, M^{I} is Ru, Ge, or Mo, and M^{II} is Ir, Os, Tl, Au, Bi, Se, or Pd.

18. The electrochemical cell of claim 13, wherein the ternary Pt-M^{I}-M^{II} alloy is PtₓM^{I}_{y}M^{II}_{z}, where x=6y=2z, x>0, M^{I} is Ru, Ge, or Mo, and M^{II} is Ir, Os, Tl, Au, Bi, Se, or Pd.

19. The electrochemical cell of claim 13, wherein the ternary Pt-M^{I}-M^{II} alloy is PtₓM^{I}_{y}M^{II}_{z}, where x+y+z=1, 0<x<0.5, 0<y<0.5, 0<z<0.5, M^{I} is Ru, Ge, or Mo, and M^{II} is Ir, Os, Tl, Au, Bi, Se, or Pd.

20. The electrochemical cell of claim 13, wherein the Pt-based alloy is mixed with Ir, Ru, an Ir—Ru alloy, IrO₂, RuO₂, and/or Ir—Ru—O.
